(19) United States
(12) Patent Application Publication
(10) Pub. No.: US 2024/0278606 A1
(43) Pub. Date: Aug. 22, 2024

(54) HITCH ASSEMBLY FOR OFF-ROAD VEHICLES

(71) Applicant: Arctic Cat Inc., Thief River Falls, MN (US)

(72) Inventors: Ethan Randall Klaphake, Thief River Falls, MN (US); Todd MacDonald, Montague (CA)

(21) Appl. No.: 18/583,801

(22) Filed: Feb. 21, 2024

Related U.S. Application Data
(60) Provisional application No. 63/543,461, filed on Oct. 10, 2023.
(60) Provisional application No. 63/447,525, filed on Feb. 22, 2023.

(51) Int. Cl. B60D 1/02; B60D 1/48

(52) U.S. Cl. CPC B60D 1/02; B60D 1/485

(57) ABSTRACT

The present disclosure relates to a hitch assembly for an off-road vehicle having different components such as a frame, an engine assembly, a suspension assembly, and a hitch assembly. The hitch assembly is coupled to a rear part of the frame of the vehicle so as to get support therefrom. The hitch assembly is configured to be attached to an external load and is further configured to provide secure attachment and support of the external load therewith.

### PRIORITY CLAIM

This application claims the benefit of priority from U.S. Provisional Patent Application Nos. 63/543,461 filed Oct. 10, 2023; and 63/447,525 filed Feb. 22, 2023, the contents of which are incorporated herein by reference.

### FIELD OF THE DISCLOSURE

The present disclosure generally relates to off-road vehicles. More particularly, the present disclosure relates to hitch assemblies for off-road vehicles.

### BACKGROUND

Towing external loads with vehicles has been well-known for many years. Different external loads, for example, trailers, cargo racks, bicycle racks, and the like, are externally attached to vehicles using a device, generally known as a receiver hitch. There are different types of cargo carriers, racks, and drawbars with or without ball mounts, hooks, or loops available for attachment with vehicle receiver hitches. For attaching a drawbar, rack, or cargo carrier, a vehicle includes a receiver hitch or a hitch mount at a rear end of the vehicle, generally exposed at the rear of the vehicle.

Various receiver hitches available for attaching external loads using cargo carriers, racks, drawbars, depending on the requirement. Some examples of the receiver hitch are a bumper mount receiver hitch, classes I-V receiver hitches, and the like. Different vehicles might have different designs of receiver hitches to connect external loads. Based on the external load to carry, the sizes of the receiver hitch vary. For instance, a class V (or heavy duty) receiver hitch has different design as compared to a bumper mount receiver hitch.

Vehicles such as off-road vehicles use compact receiver hitches or hitch mounts due to their compact size. Such hitch mounts are generally attached to a single frame member without significant surrounding support. The external load is attached using the drawbar, for instance, and the load attached to the vehicle may be heavy. Furthermore, such off-road vehicles may be involved in recovery efforts for other stuck vehicles or the vehicle itself might be stuck. Common recovery methods involve attaching a chain or recovery strap to a safety chain cut-out or loop. Other times a ball mount is used for recovery. Significant loads may be introduced in such recovery efforts. Often the loads are off-axis from the longitudinal axis of the vehicle. Accordingly, the loads might damage the hitch or even the vehicle frame to which the hitch is secured. In absence of a significant support and lack of appropriate load distribution, a portion or the whole hitch mount may be bent, broken, or dismantled due to movement of vehicles in, for example, uneven path or a steep curve, as the torque applied to the drawbar or the safety chain loops/cut-outs, and hence to the hitch mount.

Different modifications are being made while designing hitch assemblies for off-road vehicles that provide better load distribution and better support to an extension carrying an external load or used for recovery.

### SUMMARY OF THE DISCLOSURE

The present disclosure sets forth a hitch assembly for an off-road vehicle. The hitch assembly may include a base plate and a top member. The top member may be configured to be coupled to the base plate, such that, when coupled, the top member and the base plate form a cavity corresponding to a drawbar (e.g., ball mount) for receiving the drawbar therewithin. The top member may be an inverted U-shaped channel. The top member may extend from a rear end of the base plate towards a front end thereof, thereby extending the cavity from the rear end towards the front end of the base plate. The top member may be coupled to the base plate such that the rear end of the base plate is substantially aligned with a rear end of the top member. The base plate may be configured to be supported to a cross member of a frame of the vehicle adjacent to the rear end thereof. The base plate may include an aperture at each side thereof for facilitating additional attachment thereof with an external load.

In some embodiments, the present disclosure further relates to a hitch assembly for an off-road vehicle. The hitch assembly may comprise a base plate having a top surface, a top member, and a pair of supporting plates. The base plate is defined by a front end and a rear end, the base plate being supported by a cross member of a frame adjacent to the front end thereof. The top member may be defined by a pair of side walls and a top wall, in which, the top member may be configured to be coupled to the top surface of the base plate by the pair of side walls. The top member and the base plate, thus combined, make a cavity for receiving a drawbar therewithin. The pair of supporting plates may be coupled to the top surface of the base plate. Each of the pair of supporting plates may be configured to have a cut-out portion configured to receive the top member therewithin. Each of the pair of supporting plates may comprise a pair of side edges, and each of the pair of side edges of each of the supporting plates may be configured to abut an adjacent frame member and having a shape corresponding to the adjacent frame member. The pair of supporting plates may be spaced at a distance from each other. The distance between the pair of supporting plates may corresponds to an outer diameter of an adjacent frame member.

The present disclosure further sets forth an off-road vehicle comprising a frame, an engine assembly configured to be attached with the frame. The hitch assembly may a base plate and a top member. The top member may be configured to be coupled to the base plate. The top member and the base plate, when coupled, form a cavity corresponding to a drawbar for receiving the drawbar therewithin. The top member may be an inverted U-shaped channel. The top member may extend from a rear end of the base plate towards a front end thereof, thereby extending the cavity from the rear end towards the front end of the base plate. The top member may be coupled to the base plate such that the rear end of the base plate is substantially aligned with a rear end of the top member. The base plate may be configured to be supported to a cross member of a frame of the vehicle adjacent to the rear end thereof. The base plate may include an aperture at each side thereof for facilitating additional attachment thereof with an external load.

### BRIEF DESCRIPTION OF THE DRAWINGS

A more complete understanding of the present disclosure may be derived by referring to the detailed description and claims when considered in connection with the Figures, wherein like reference numerals refer to similar elements throughout the Figures.

FIG. 1 is an exemplary perspective view of an off-road utility vehicle in accordance with the present disclosure.

FIGS. 2-3 illustrate exemplary isometric views of a frame and an engine assembly of an off-road vehicle in accordance with the present disclosure.

FIG. 4 illustrates an exemplary hitch assembly of an off-road vehicle in accordance with the present disclosure.

FIG. 5 illustrates an exemplary partially exploded view of a hitch assembly of an off-road vehicle in accordance with the present disclosure.

FIGS. 6-7 illustrate exemplary exploded views of a hitch assembly of an off-road vehicle in accordance with the present disclosure.

FIG. 8 illustrates a bottom isometric view of a hitch assembly coupled to a frame of an off-road vehicle according to an embodiment of the present disclosure.

FIG. 9 illustrates an exemplary rear view of a hitch assembly coupled to a frame of an off-road vehicle according to an embodiment of the present disclosure.

FIG. 10 illustrates an exemplary bottom view of a hitch assembly coupled to a frame of an off-road vehicle according to an embodiment of the present disclosure.

### DETAILED DESCRIPTION

The following description is of exemplary embodiments of the invention only, and is not intended to limit the scope, applicability, or configuration of the invention. Rather, the following description is intended to provide a convenient illustration for implementing various embodiments of the invention. As will become apparent, various changes may be made in the function and arrangement of the elements described in these embodiments without departing from the scope of the invention as set forth herein. It should be appreciated that the description herein may be adapted to be employed with alternatively configured devices having different shapes, components, attachment mechanisms, and the like and still fall within the scope of the present invention. Thus, the detailed description herein is presented for purposes of illustration only and not of limitation.

Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Embodiments of the present disclosure describe an off-road vehicle having different features such as a frame structure, an engine assembly, a suspension assembly, and a hitch assembly. The term ‘engine assembly’ used throughout the disclosure relates to an engine and a transmission, such as a transaxle, of an off-road vehicle, and particularly, the engine assembly comprises an engine, a transaxle and/or a transmission, and associated parts. The hitch assembly may comprise a receiver hitch, and a corresponding supporting assembly. Components described herein are not limited to off-road vehicles and may be utilized for different vehicles. For example, the hitch assembly may be used in different models of on-road or off-road vehicles for providing better attachment of an external load with the vehicle. In addition, the hitch assembly may provide secure attachment of the payload, thereby providing better control over movement of an extension carrying the external load.

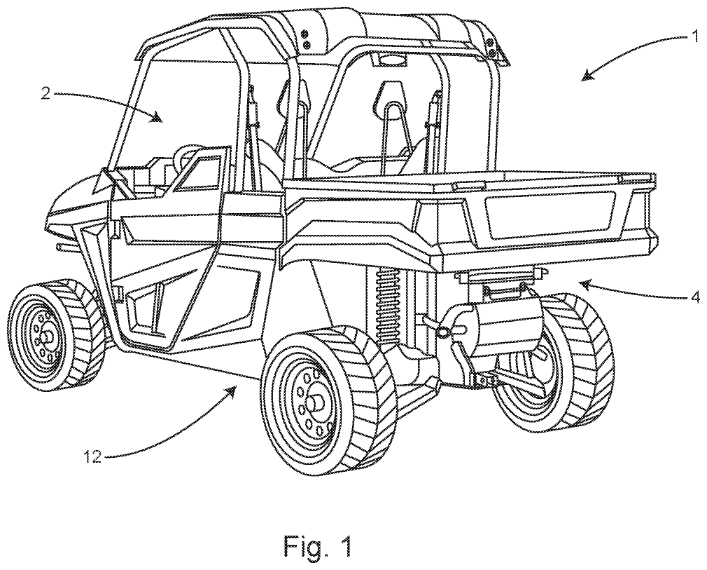

Reference is now made to FIG. 1, which represents an off-road vehicle 1 according to some embodiments of the present disclosure. The vehicle 1 generally includes a frame 12 which extends from a front part of the vehicle 1 to a rear part thereof. The frame 12 may include different structures and may be configured to be divided to generally define different areas of the vehicle 1. For instance, the frame 12 may be divided into two parts. A front part of part of the frame 12 may define a seating area 2. The seating area 2 of the vehicle 1 comprises a steering assembly of the vehicle 1, corresponding components, and one or more seats for providing seating to one or more riders. The rear part of the frame 12 may include an engine area 4 and may provide support to different assemblies.

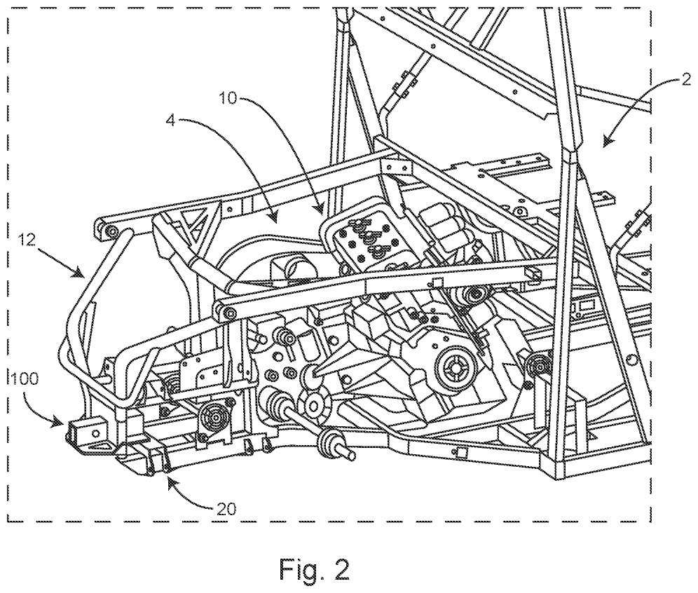

The engine area 4 may be configured to receive an engine assembly 10 of the vehicle 1 (seen e.g., in FIGS. 2-3). The rear part of the frame 12 may further include a frame structure 20 to provide support to a rear suspension assembly and a hitch assembly 100. Accordingly, the rear part of the frame 12 may include a structure that facilitates coupling and support to the rear suspension assembly and a separate structure to facilitate coupling and support to the hitch assembly 100.

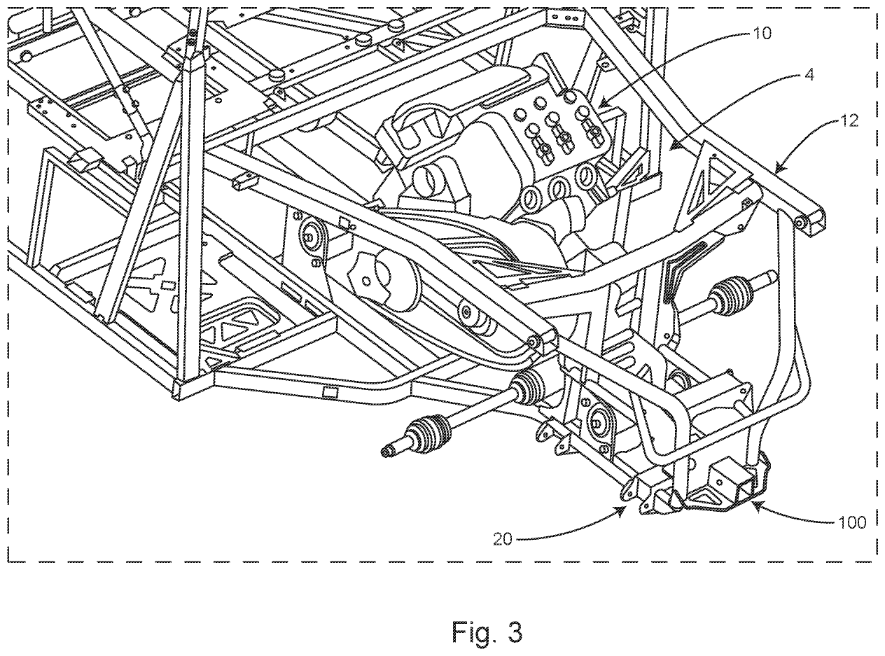

Reference is now made to FIG. 4, which illustrates an exemplary hitch assembly 100 in accordance with the present disclosure. The hitch assembly 100 may be configured to be attached to a rear part of the frame of the vehicle. Specifically, the hitch assembly 100 may be secured to a frame structure 20 facilitating attachment of a suspension assembly of the vehicle 1. More specifically, the hitch assembly 100 may be supported by a cross member 22 of the frame 12 of the vehicle 1. The hitch assembly 100 may include a cavity H to receive a drawbar therewithin.

The hitch assembly 100 may include a base plate 102 and a top member 120. The top member 120 may be configured to be coupled to the base plate 102. The base plate 102 and the top member 120, when coupled together, may be configured to form the cavity H for receiving a drawbar therewithin. It is to be noted that dimensions of the cavity H may be designed such as to receive the drawbar therewithin with a small amount of clearance. In an embodiment, the top member 120 may be coupled to the base plate 102 by means of welding.

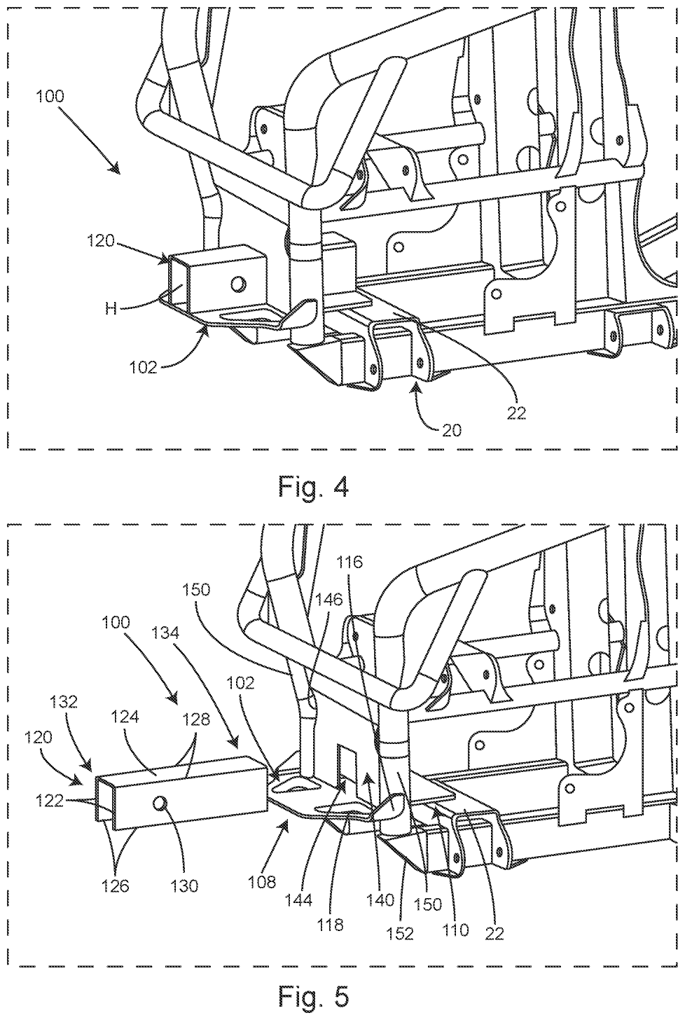

The top member 120 may be an inverted U-shaped channel (seen e.g., in FIG. 5). The top member 120 may extend from a rear end 132 towards a front end 134 thereof. The top member 120 may be defined by a pair of side walls 122 and a top wall 124. Each of the pair of side walls 122 may include a first edge 126 and a second edge 128. The first edge 126 of each of the pair of side walls 122 may be configured to be attached to the base plate 102. The second edge 128 of each of the pair of side walls 122 may abut a pair of edges of the top wall 124. In other words, the top wall 124 may extend between the second edge 128 of each of the pair of side walls 122, thereby making the top member 120 in shape of an inverted U-shaped channel. Preferably, the top wall and side walls are integrally formed such as by bends between the top wall and the side walls. Each of the pair of side walls 122 may include a first hole 130 proximal to the rear end. The first hole 130 at each of the pair of side walls 122 may be configured to receive a hitch pin after receiving the drawbar within the cavity H.

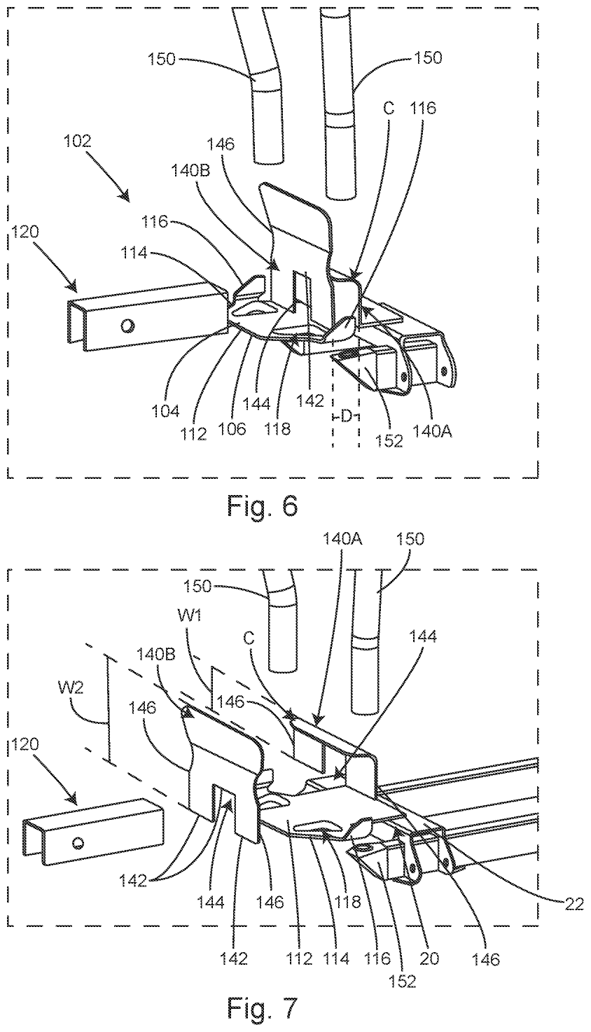

The base plate 102 of the hitch assembly 100 may be defined by a top surface 104 and a bottom surface 106 (seen e.g., in FIG. 6). The top surface 104 of the base plate 102 may be configured to be coupled with the first edge 126 of each of the side walls 122 of the top member 120 to form the cavity H. The base plate 102 may be divided in to three portions, a pair of side portions 114 and a middle portion 112. The base plate 102 may be configured to be coupled to the top member 120 at the middle portion 112 on the top surface 104 thereof.

The base plate 102 may further be defined by a front end 110 and a rear end 108 (seen e.g., in FIG. 5). The base plate 102 may be supported by a portion of frame structure of the frame. In some embodiments, the base plate 102 may be supported by a portion of the frame 12 proximal to a rear suspension assembly (seen e.g., in FIGS. 4-5). Particularly, the base plate 102 may be supported by a cross member 22, which is designed for attachment of the rear suspension assembly with the frame 12. More particularly, the base plate 102 may be supported by the cross member 22 adjacent to the front end 110 thereof. Accordingly, the hitch assembly 100 may be configured to get a first support at the front end 110 of the base plate 102 from the cross member 22 of the frame 12.

It is submitted that the top member 120 may be coupled with the base plate 102 such that the top member 120 extends from the rear end 108 of the base plate 102 towards the front end 110 such that the rear end 108 of the base plate 102 is substantially aligned with the rear end 132 of the top member 120. Such arrangement provides better alignment of the hitch assembly 100.

In some embodiments, each of the pair of side portions 114 of the base plate 102 may include an aperture 118 (seen e.g., in FIG. 6). The aperture 118 may be configured to facilitate securement of a hook or ring therewith, such as for securing a safety chain. The aperture 118 may further be used to tie a rope, recovery strap, or chain therewith. Accordingly, the aperture 118 may provide additional support and provision for securing the external load attached to the drawbar. It may also be used for recovery efforts.

The base plate 102 may further include a flange 116 at each of the side portions 114 (FIGS. 5-7). Particularly, the flange 116 may extend upwardly from an outer side of each of the pair of side portions 114. The flange 116, at each side, may be fixed to an adjacent frame member 150, defining a rear structure of the frame (seen, e.g., in FIG. 5). Accordingly, the attachment of the flanges 116 with the adjacent frame members 150 may provide primary support to the hitch assembly 100, especially for the base plate structure surrounding the apertures 118.

The hitch assembly 100 may further include at least one supporting plate 140 (seen e.g., in FIGS. 5-7). The at least one supporting plate 140 may be configured to be coupled to the top surface 104 of the base plate 102. The at least one supporting plate 140 may be configured to be positioned substantially transverse to the base plate 102. In some embodiments, the at least one supporting plate 140 may be configured to be positioned perpendicular to the base plate 102. Optionally, the at least one supporting plate 140 may be configured to be positioned at an acute angle or an obtuse angle with the base plate 102.

In some embodiments, the at least one supporting plate 140 may be defined by a bottom edge 142 and a plurality of side edges 146. The bottom edge 142 of the at least one supporting plate 140 may include a cut-out portion 144. The cut-out portion 144 may be defined so as to receive the top member 120 therewithin. In other words, the cut-out portion 144 may correspond to an outer periphery of the top member 120 so as to comfortably receive the top member 120 therewithin. The plurality of side edges 146 of the at least one supporting plate 140 may be configured to abut and be fixed to an adjacent frame member 150 on both sides thereof (seen e.g., in FIG. 5). For the same, each of the plurality of side edges 146 of the at least one supporting plate 140 may have a shape corresponding to the adjacent frame member 150 (seen e.g., in FIG. 5). Accordingly, the at least one supporting plate 140, and hence the hitch assembly 100, may get a third support. The at least one supporting plate 140 may be coupled to the top surface 104 of the base plate 102 by means of welding.

In some embodiments, the hitch assembly 100 may include a pair of supporting plates 140A, 140B (seen e.g., in FIGS. 6-7). The pair of supporting plates 140 may be positioned on the top surface 104 of the base plate 102 such that the pair of supporting plates 140 are substantially transverse to the base plate 102. In some embodiments, the pair of supporting plates 140 may be configured to be positioned perpendicular to the base plate 102. Optionally, the pair of supporting plates 140 may be configured to be positioned at an acute angle or an obtuse angle with the base plate 102.

The pair of supporting plates 140 may be placed at a distance D from each other (seen e.g., in FIG. 6). In other words, a first plate 140A of the pair of supporting plates 140 may be place at a distance D from a second plate 140B thereof. The distance D between the two plates may correspond to an outer diameter of the adjacent frame member 150. Both plates 140 are preferably welded to frame member 150.

In some embodiments, each of the pair of supporting plates 140 may have different widths (seen e.g., in FIG. 7). For instance, the first supporting plate 140A may have a first width W1 and the second supporting plate 140B may have a second width W2. In an embodiment, the first width W1 may be smaller than the second width W2. Further, an upper portion of the first supporting plate 140A may abut and be welded to the second supporting plate 140B (seen e.g., in FIGS. 6-7). For the same, the upper portion of the first supporting plate 140A may have a curve C to facilitate such abutment. It is to be noted that the pair of supporting plates 140 are positioned such that at least a portion of both the pair of the supporting plates 140 is parallel to each other. Specifically, a lower portion of each of the pair supporting plates 140 is parallel to each other.

Each of the pair of supporting plates 140 may be defined by a bottom edge 142 and side edges 146. The bottom edge 142 of each of the pair of supporting plates 140 may be configured to have a cut-out portion 144. The cut-out portion of each of the pair of supporting plates 140 may be corresponding to an outer periphery of the top member 120 so as to receive the top member 120 therewithin. The edges of the cut-out portions may be welded or otherwise secured to the top member 120. In an embodiment, the side edges 146 of the pair of supporting plates 140 may abut an adjacent frame member 150 at each side thereof. For the same, each of the side edges 146 of the pair of supporting plates 140 may have a shape corresponding to the adjacent frame member 150. It is to be noted that the adjacent frame member 150 may be a hollow pipe and the pair of supporting plates 140 may be shaped according to an outer diameter and a shape of the hollow pipe.

Accordingly, the hitch assembly 100 may get additional support from the adjacent frame member 150 at each side thereof (seen e.g., in FIGS. 5-7). In some embodiments, the adjacent frame member 150 may be configured to be placed proximal to the frame structure 20 of the rear suspension assembly. For the same, the rear frame structure may include an extension 152 (seen e.g., in FIGS. 5-7) attached to the rear frame structure. In an embodiment, the adjacent frame member 150 is a circular hollow pipe configured to be fitted on the extension 152. The adjacent frame member 150 may have a diameter.

In some embodiments, the base plate 102 and the top member 120 may be used as a hitch mount, i.e., without use of the supporting plates 140. Such arrangement may be referred as a partial hitch. In such embodiments, the partial hitch may be configured to be attached to the frame 12 for getting support therefrom. In an embodiment, the partial hitch may be attached to the adjacent frame member 150, by means of welding, at each of the first side and the second side for providing support thereto.

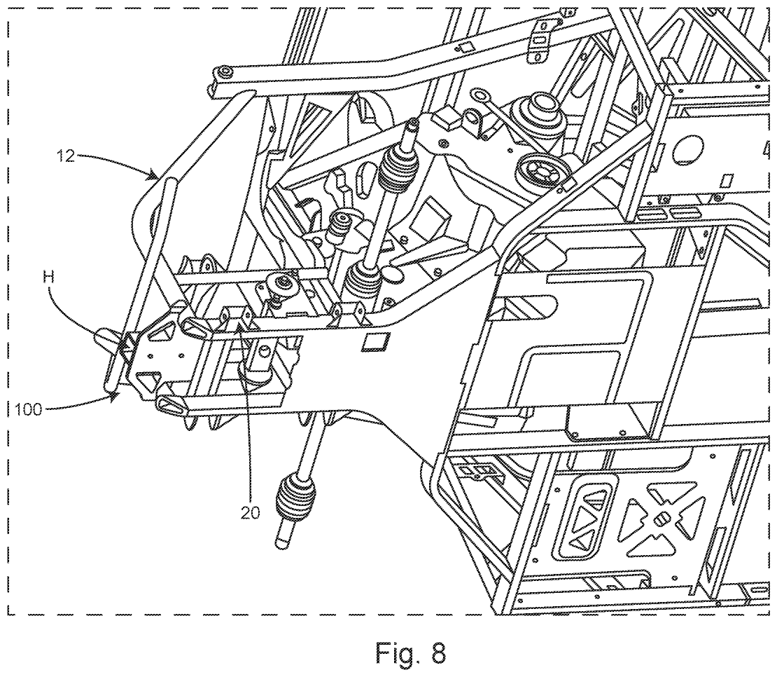

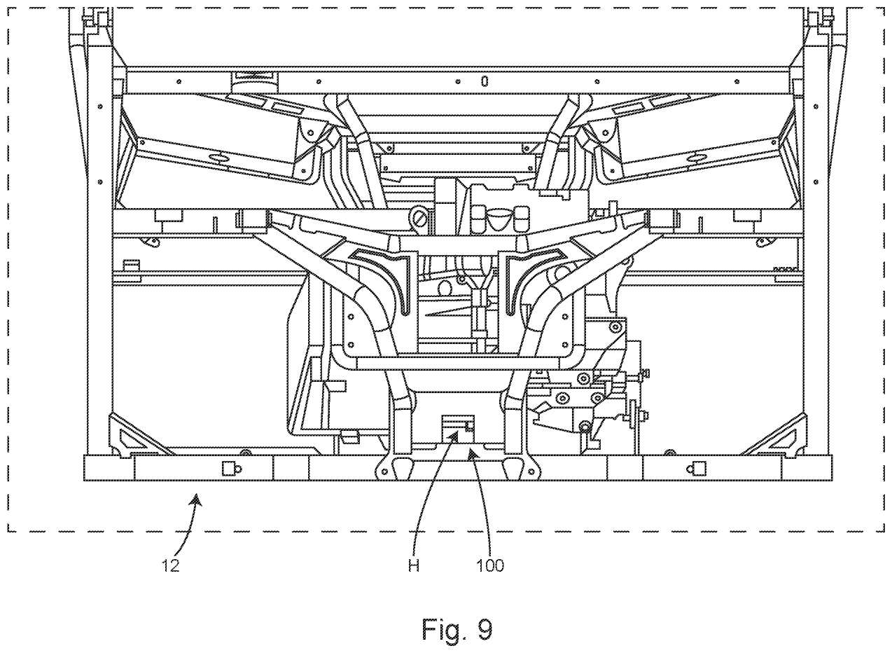

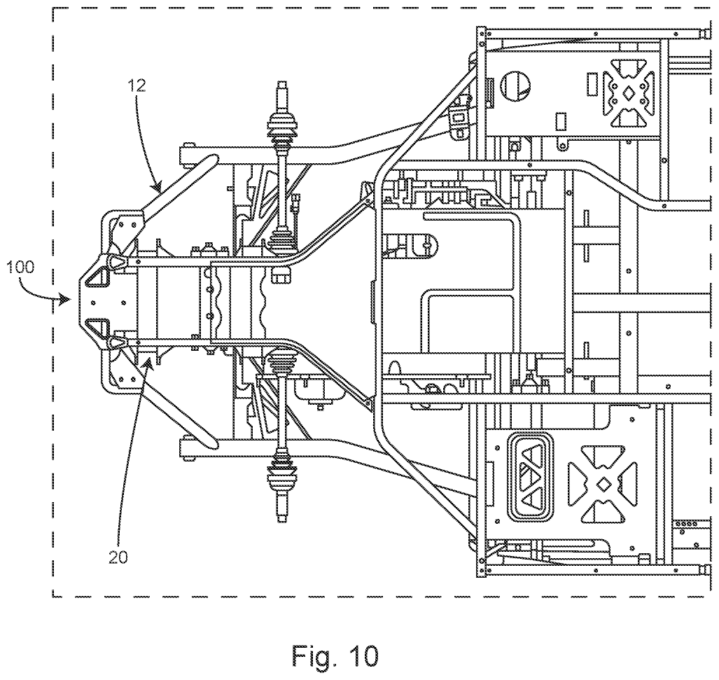

FIGS. 8-10 illustrate different views of the hitch assembly 100 coupled to the frame 12 of the vehicle 1. More specifically, FIG. 8 illustrates a bottom isometric view of the rear frame structure having the hitch assembly 100 attached thereto, while FIGS. 9-10 illustrate a rear view and a bottom view, respectively, of the hitch assembly 100 coupled to the frame of the vehicle.

It is to be noted that different components of the hitch assembly 100 may be attached or coupled with each other and with corresponding frame member by means of welding. Accordingly, a firm coupling is achieved in the frame 12 of the vehicle 1, including the hitch assembly 100.

The hitch assembly 100 of the present disclosure is structured so as to get support from the frame 12 at different points, for instance, the first support from the cross member 22 of the frame 12, the second and the third supports from the adjacent frame member 150 of a rear frame structure. Hence, the hitch assembly 100 receives an increased overall support. Such structure facilitates better distribution of load when an external load is attached thereto using a drawbar. Moreover, because of the firm attachment of the hitch assembly 100 with the frame 12, for instance, at the rear frame structure, the drawbar attached with the hitch assembly 100 is better supported with application of an external load. Hence, a strong attachment between the drawbar and the hitch assembly 100 is achieved. The apertures 118 are also better supported for loads, including recovery loads, applied thereto. As a result, even in the case of off-axis loads, such as pulling a load that is not directly rearward of the vehicle, the hitch assembly 100 provides stable attachment.

It is to be noted that different values and parameters mentioned in the description are exemplary in nature and are not intended to bound the specification in any manner.

Finally, while the present invention has been described above with reference to various exemplary embodiments, many changes, combinations, and modifications may be made to the exemplary embodiments without departing from the scope of the present invention. For example, the various components may be implemented in alternative ways. These alternatives can be suitably selected depending upon the particular application or in consideration of any number of factors associated with the operation of the device. In addition, the techniques described herein may be extended or modified for use with other types of devices. These and other changes or modifications are intended to be included within the scope of the present invention.

What is claimed is:

1. A hitch assembly for an off-road vehicle, the hitch assembly comprising:
a base plate; and
a top member configured to be coupled to the base plate;
wherein the base plate and the top member, when coupled, form a cavity corresponding to a drawbar for receiving the drawbar therewithin.

2. The hitch assembly of claim 1, wherein the base plate is defined by a top surface, a bottom surface, a frond end, and a rear end, and the top member is defined by a pair of side walls and a top wall, each of the pair of side walls comprising a first edge and a second edge.

3. The hitch assembly of claim 2, wherein the first edge of each of the pair of side walls is configured to be coupled to the base plate, and the top wall extends between the second edge of each of the pair of side walls.

4. The hitch assembly of claim 1, wherein the top member is an inverted U-shaped channel.

5. The hitch assembly of claim 1, wherein the top member extends from a rear end of the base plate towards a front end thereof, thereby extending the cavity from the rear end towards the front end of the base plate, the rear end of the base plate being substantially aligned with a rear end of the top member.

6. The hitch assembly of claim 2, wherein the bottom surface of the base plate adjacent to the front end is supported on a cross member of a frame of the vehicle.

7. The hitch assembly of claim 1, wherein the base plate comprises a pair of side portions, and a middle portion, wherein the top member is configured to be coupled at the middle portion on a top surface of the base plate.

8. The hitch assembly of claim 7, wherein each of the pair of side portions of the base plate comprises an aperture.

9. The hitch assembly of claim 7, wherein each of the pair of side portions comprises a flange extending upwardly from an outer side thereof, the flange configured to be coupled to an adjacent frame member, thereby providing support to the base plate at a front end.

10. The hitch assembly of claim 1, further comprising at least one supporting plate coupled to the base plate, the at least one supporting plate comprising a bottom edge having a cut-out portion corresponding to an outer periphery of the top member.

11. The hitch assembly of claim 10, wherein the at least one supporting plate comprises a pair of side edges, each of the pair of side edges abutting an adjacent frame member and having a shape corresponding to the adjacent frame member.

12. The hitch assembly of claim 10, wherein the at least one supporting plate is positioned substantially transverse to the base plate and is configured to receive the top member within the cut-out portion.

13. The hitch assembly of claim 1, further comprising a pair of supporting plates coupled to a top surface of the base plate, wherein each of the pair of supporting plates comprises a bottom edge coupled to the top surface of the base plate, wherein the pair of supporting plates are positioned substantially transverse to the base plate.

14. The hitch assembly of claim 13, wherein the bottom edge of each of the pair of supporting plates comprises a cut-out portion to receive the top member therewithin.

15. The hitch assembly of claim 13, wherein the pair of supporting plates are spaced at a distance from each other, wherein the distance corresponds to an outer diameter of an adjacent frame member.

16. The hitch assembly of claim 13, wherein the first supporting plate is joined to the second supporting plate at top edges thereof.

17. A hitch assembly for an off-road vehicle, the hitch assembly comprising:
a base plate comprising a top surface;
a top member defined by a pair of side walls and a top wall, the top member configured to be coupled to the top surface of the base plate by the pair of side walls, thereby making a cavity for receiving a drawbar therewithin; and
a pair of supporting plates coupled to the top surface of the base plate, each of the pair of supporting plates having a cut-out portion configured to receive the top member therewithin.

18. The hitch assembly of claim 17, wherein the base plate is defined by a front end and a rear end, the base plate being supported by a cross member of a frame adjacent to the front end thereof, and wherein the top member extends from the rear end of the base plate towards the front end thereof, thereby extending the cavity from the rear end towards the front end of the base plate, the rear end of the base plate being substantially aligned with a rear end of the top member.

19. The hitch assembly of claim 17, wherein each of the pair of supporting plates is transverse to the base plate and transverse to the top member, the supporting plates each having a pair of side edges, each of the pair of side edges of each of the supporting plates configured to abut an adjacent frame member.

20. An off-road vehicle comprising a frame, an engine assembly configured to be attached with the frame, and a hitch assembly;
wherein the hitch assembly comprises:
a base plate; and
a top member configured to be coupled to the base plate;
wherein the base plate and the top member, when coupled, form a cavity corresponding to a drawbar for receiving the drawbar therewithin.
